(19) United States
(12) Patent Application Publication
(10) Pub. No.: US 2008/0041827 A1
(43) Pub. Date: Feb. 21, 2008

(54) Resistance Spot Welding Monitoring System and Method

(76) Inventors: Wei Li, Shoreline, WA (US); Daniel Cerjanec, Shelby Township, MI (US); Gerald A. Grzadzinski, Sterling Heights, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/747,069

(22) Filed: May 10, 2007

Related U.S. Application Data
(60) Provisional application No. 60/803,311, filed on May 26, 2006.

(51) Int. Cl. B23K 11/24

(52) U.S. Cl. 219/109

(57) ABSTRACT

A resistance spot welding monitoring system includes a plurality of sensors coupled to a resistance spot welding system to receive welding data produced during a welding operation. The monitoring system further includes a nugget prediction system. The welding data is indicative of welding parameters used to produce the weld nugget. The nugget prediction system retrieves the welding data and predicts a nugget size based upon the welding data received from the plurality of sensors. Additionally, the nugget prediction system generates a nugget size signal. The monitoring system also includes an indicator that receives the nugget size signal and notifies an operator of a predicted nugget size.

### CROSS REFERENCE TO RELATED APPLICATION(S)

This application claims the benefit of U.S. Provisional Patent Application Ser. No. 60/803,311, filed May 26, 2008.

### FIELD OF THE INVENTION

The present invention relates to resistance spot weld quality. More specifically, the present invention relates to a system and method for monitoring resistance spot welding systems.

### BACKGROUND OF THE INVENTION

On-line monitoring of resistance spot welding quality is of great importance in the automotive industry. The quality of the spot welds may affect the structural integrity of auto-body assemblies, and, thereby, the crashworthiness of an entire vehicle may become affected. It is well known that significant quality variation exists among resistance spot welds. Because of this variation among the resistance spot welds, a structure may include many redundant welds. This contributes to increase cost and wasted materials. Additionally, frequent destructive tests are required to ensure the quality assurance of a structure. Destructive tests include peeling and tearing a weld structure to determine whether an acceptable weld nugget was formed as the structure was welded. Non-destructive tests such as ultrasonic testing have been attempted; however, this method largely depends on well-trained inspectors. Additionally, the non-destructive tests can only be performed off-line after an entire welded structure is completed from a manufacturing assembly line.

In order to improve the quality of a resistance spot welding process, an on-line weld quality monitoring system is needed to check the quality of every weld.

### SUMMARY OF THE INVENTION

A resistance spot welding monitoring system includes a plurality of sensors that are adapted to be coupled to a resistance spot welding system for receipt of welding data. The system further includes a nugget prediction system coupled to the plurality of sensors and configured to retrieving inputs indicative of the welding parameters used to produce the weld nugget. The nugget prediction system is operable to predict a nugget size based upon the welding data received from the plurality of sensors. Additionally, the nugget prediction system transmits a nugget size signal. The system also includes an indicator coupled to the nugget prediction system. The indicator receives the nugget size signal and notifies an operator of a predicted nugget size.

In another aspect, a method for monitoring resistance spot welding includes sensing welding data associated with a welding operation producing a weld nugget within a plurality of metal materials. The welding data is retrieved, and a nugget size of the weld nugget is predicted based on the welding data to alert an operator of the nugget size.

### BRIEF DESCRIPTION OF THE DRAWINGS

The present invention will become more fully understood from the detailed description and the accompanying drawings, wherein:

FIG. 1 is a block diagram of a resistance spot welding monitoring system for a preferred embodiment of the present invention;

FIG. 2 is a diagrammatic view of a pair of electrodes welding a plurality of metal materials in accordance with the present invention;

FIG. 3 is a block diagram of a nugget prediction system in accordance with the present invention;

FIG. 4 is an exemplary dynamic resistance curve model in accordance with the present invention; and

FIG. 5 is a flow chart of an operation preformed by the resistance spot welding monitoring system in accordance with the present invention.

### DETAILED DESCRIPTION OF THE PREFERRED EMBODIMENTS

The following description is merely exemplary in nature and is not intended to limit the present disclosure, application, or uses.

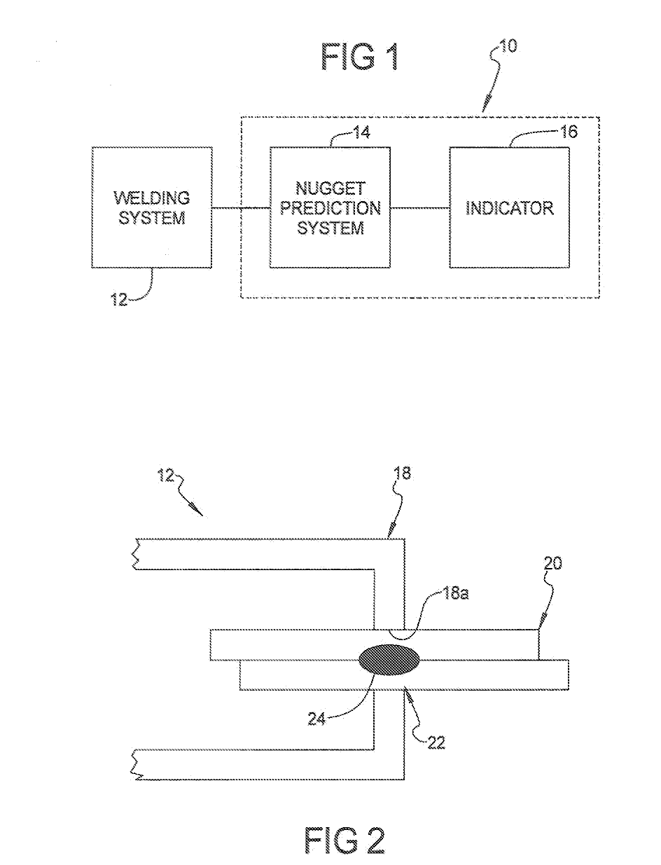

FIG. 1 illustrates a resistance spot welding monitoring system 10. The resistance spot welding monitoring system 10 is coupled to a welding system 12. The resistance spot welding monitoring system 10 includes a nugget prediction system 14, and an indicator 16. The welding system 12 is coupled to the nugget prediction system 14. The nugget prediction system 14 is, in turn, coupled to the indicator 16.

Referring to FIG. 2, the welding system 12 having a pair of electrodes 18 utilizes a resistance spot welding process to join a plurality of metal materials 20 based on a plurality of welding parameters. The plurality of metal materials 20 may comprise separate sheets of metal material. As an electrical signal is emitted by the pair of electrodes 18, welding current flows through tips 18a of the pair of electrodes 18 to join the plurality of metal materials 20 forming a weld 22 to marry the plurality of metal materials 20. The weld 22 is formed as the resistance of the plurality of metal materials 20 to the electrical current signal flows, causing localized heating in a weld Joint (not shown). Additionally, as each of the plurality of metal materials 20 reaches their melting point, a weld nugget 24 is formed at the weld 22.

The welding parameters under which the weld nugget 24 is formed may include an electrical energy signal produced at the pair of electrodes 18 of the welding system 12 to form the weld nugget 24 and a contact area between the pair of electrodes 18 and the plurality of metal materials 20. The electrical energy signal includes a welding current and a tip voltage used to produce the weld. The welding parameters may also include, but are not limited to, a material thickness, a welding time, an electrode force, and a dynamic resistance. The material thickness includes a thickness of each of the plurality of metal materials 20. The welding time is indicative of the amount of time utilized to form the welded plurality of metal materials. The electrode force is indicative of a force used to damp and hold the welded plurality of metal materials in close contact with the pair of electrodes 18 when forming the weld nugget 24. The dynamic resistance is indicative of a resistance across the pair of electrodes 18 and the plurality of metal materials 20, during the welding process. The welding parameters will be further discussed below.

The nugget prediction system 14 is configured to receive inputs indicative of the welding parameters under which the welding system 12 operates to produce the weld nugget 24. Once the welding parameters are obtained, the nugget prediction system 14 predicts the nugget size of the weld nugget 24.

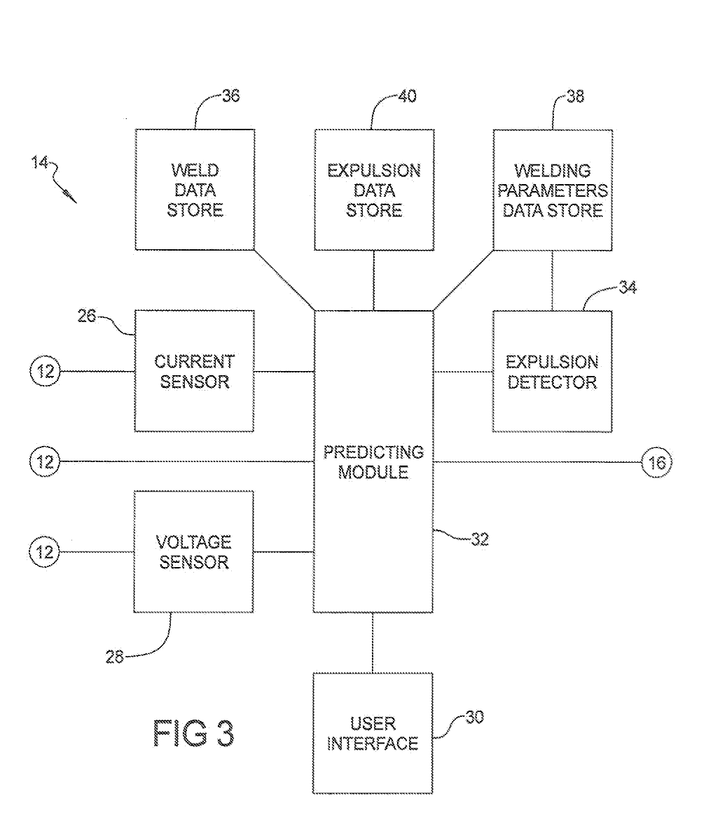

Referring to FIG. 3, the nugget prediction system 14 includes a current sensor 26, a voltage sensor 28, a user interface 30, a predicting module 32, an expulsion detector 34, a weld data store 36, a welding parameters data store 38, and an expulsion data store 40. The welding system 12 is coupled to the voltage and current sensors 26, 28. The welding system 12 is also coupled to the predicting module 32. Additionally, the voltage and current sensors 26, 28 are coupled to the predicting module 32. The user interface 30 is also coupled to the predicting module 32. Each of the weld data store 36, the welding parameters data store 38, and the expulsion data store 40 is coupled to the predicting module 32. The welding parameters data store is also coupled to the expulsion detector 34. The predicting module 32 is, in turn, coupled to the expulsion detector 34 and the indicator 16.

The current sensor 26 detects the welding current used to form the weld nugget 24. The welding current is a welding parameter indicative of current applied to the welded plurality of metal materials. The current sensor transmits the welding current to the predicting module 32.

The voltage sensor 28 detects the tip voltage used to form the weld nugget 24. The tip voltage is a welding parameter indicative of a voltage across the electrode tips 18a. The voltage sensor 28 transmits the tip voltage to the predicting module 32.

The user interface 30 is configured to allow an operator to input at least one welding parameter, such as material thickness data. Additionally, the user interface 30 is configured to transmit a request signal initiated by the operator to retrieve any one or a combination of weld data, welding parameter data, and expulsion data for a selected period.

Either the welding system 12 or the user interface 30 may transmit the welding parameters as input signals such as the energy, the material thickness, the welding time, and the electrode force.

The predicting module 32 is configured to receive the input signals from the welding system 12, the voltage sensor 28, the current sensor 26, and the user interface 30. The predicting module 32 is further configured to predict the nugget size of the weld nugget 24. Additionally, the predicting module 32 may determine the welding parameters from associated real time signals retrieved from the welding system 12 such as the contact area and dynamic resistance. The contact area and dynamic resistance will be further discussed later.

The predicting module 32 is further configured to determine the energy and contact area in order to predict the nugget size of the weld nugget 24. In predicting the nugget size, the estimated contact area plays an important role. It provides critical information on how much energy is required to make a good weld. Contact area not only quantifies electrode wear on each electrode in a production environment, but also reflects the electrode force, misalignment, and poor fit-up conditions in the welding process. Each of the above mentioned factors affect the nugget size when the welding energy is given.

The estimated contact area is determined using the dynamic resistance. The following model determines the estimated contact area. The model considers the force and determines a sheet-to-sheet contact area based on both the electrode force and the dynamic resistance. A contact radius at the electrode to surface interface is denoted r. The contact radius at the surface-to-surface interface is assumed larger than that at the electrode-to-interface surface. The difference is denoted as rₑ. The thickness of each sheet of metal material associated with the plurality of metal materials 20 is h. The ambient temperature of the welding zone is assumed to be Tₒ. The heat loss from the welding zone to the surrounding environment is characterized using two heat transfer coefficients, k₁ and k₂. The heat transfer coefficients, k₁ and k₂, are related to the thermal conductivities of the pair of electrodes 18 and the plurality of metal materials 20. Additionally, it is assumed that temperature is linearly decreasing outside a lumped volume and that the distance between the lumped volume and the location where the temperature remains at an ambient temperature is in contact The lumped volume includes a section of volume at a point where the tips 18a of the electrodes 18 and a mass of the plurality of metal materials 20 directly between the electrodes 18. Therefore, a total heat loss can be represented as

H=−k₁aₜ(T−Tₒ)−k₂Aₛ(T−Tₒ) Equation 1

where Aₜ is the contact area at the pair of electrodes 18 to surface interfaces and Aₛ is the side surface area of the lumped volume. These areas can be obtained as follows:

Aₜ=2πr² Equation 2

Aₛ=2π(2r+rₑ)\sqrt{h²+rₑ²} Equation 3

### The transient heat transfer process for the lumped mass can be represented as

$$ρ cV \frac{\partial T}{\partial t} = {t}^{2} {R}_{T} - {k}_{1} {A}_{t} ( T - {T}_{o} ) - {k}_{2} {A}_{s} ( T - {T}_{o} ) \qquad Equation 4$$

where ρ is the density of the sheet metal, c is the specific heat, V is the volume of the lumped mass, i is the welding current, and R_{T} is the instantaneous electrical resistance. The volume of the lumped mass can be obtained as

$$V = \frac{2 π h}{3} ( 3 {r}^{2} + 3 {rr}_{e} + {r}_{e}^{2} ) \qquad Equation 5$$

The predicting module 32 is operable to determine the dynamic resistance R_{T}. The dynamic resistance is determined based on the tip voltage and the welding current. The dynamic resistance fluctuates during the welding process due to the temperature and contact area change. Thus, the dynamic resistance can be modeled as

$$\begin{matrix}{R}_{T} = {\int }_{0}^{h} {ρ}_{T} \frac{1}{{A}_{x}} d x \\ = {\int }_{0}^{h} {ρ}_{T} \frac{1}{{π ( r + {r}_{e} ( 1 - \frac{x}{h} ) )}^{2}} d x \\ = {ρ}_{T} \frac{h}{π r ( r + {r}_{e} )}\end{matrix} \qquad Equation 6$$

where ρ_{T} is the temperature dependent electrical resistance. The temperature ρ_{T} can be related to the temperature of the lumped mass through the following relationship.

ρ_{T}=ρₑ(1+α(T−Tₒ)) Equation 7

where α is a temperature coefficient of the resistance, and ρₑ is an initial resistance at ambient temperature.

The predicting module 32 is also configured to receive a severe expulsion signal from the expulsion detector 34. The severe expulsion signal indicates whether a severe expulsion has occurred for the weld nugget 24. If the severe expulsion signal indicates that a severe expulsion has occurred, the predicting module 32 transmits the severe expulsion signal to the expulsion data store 40 for storage. Additionally, the predicting module 32 may transmit a signal to the indicator 16 to alert the operator that a severe expulsion has occurred. The predicting module 32 also terminates the prediction for the nugget size. If, however, the severe expulsion signal indicates that a severe expulsion has not occurred, the predicting module 32 continues to predict the nugget size.

The predicting module 32 is further configured to predict the nugget size using a nugget-size-prediction algorithm. The nugget size prediction algorithm is simple and easy to calibrate. The resistance spot welding process is a transient heat transfer process of Equation 4 and can he rewritten and expressed as shown in Equation 8.

$$ρ c \cdot h \cdot \frac{π {d}_{n}^{2}}{4} Δ {T}_{m} = {i}^{2} R Δ t - ( {k}_{1} \cdot \frac{π {d}_{c}^{2}}{2} + {k}_{2} \cdot h \cdot π {d}_{c} ) Δ {T}_{m} Δ t \qquad Equation 8$$

where h is the thickness of the material, dₙ is the nugget size, ΔTₘ is the temperature increase from the room temperature to the melting temperature of the plurality of metal materials 20, Δt is the welding time, and d_{c} is the contact area. Equation 8 can be further simplified into

$${d}_{n}^{2} = {α}_{0} + {α}_{1} ( \frac{E}{h} ) + {α}_{2} ( \frac{{d}_{c}^{2} \cdot Δ t}{h} ) + {α}_{3} ( {d}_{c} \cdot Δ t ) \qquad Equation 9$$

where αs are the coefficients of the linear equation and needed to be calibrated. This equation captures the thermal-electrical effects of the resistance spot welding process, it does not, however, explicitly include the electrode force effect. The force effect has been considered important in resistance welding. In order to include it, the following generic model structure is used.

$${d}_{n}^{2} = {α}_{0} + {α}_{1} ( \frac{E}{h} ) + {α}_{2} ( \frac{{d}_{c}^{2} \cdot Δ t}{h} ) + {α}_{3} ( {d}_{c} \cdot Δ t ) + {α}_{4} F \qquad Equation 10$$

where F is the electrode force and α₄ is the coefficient of the electrode force.

As previously stated above, the welding parameters energy E, the material thickness h, the welding time Δt, and the electrode force F can be obtained as input signals from the welding system 12 or the user interface 30. Alternatively, the predicting module 32 may determine the above-mentioned welding parameters by using associated real time signals retrieved from the welding system 12. The contact area d_{c} can be estimated based on the dynamic resistance, as discussed above. The coefficients α can be calibrated through linear regression using experimental data.

The predicting module 32 is further configured to receive weld data indicating that the pair of electrodes 18 has produced the weld nugget 24. The predicting module 32 transmits the weld data to the weld data store 36. The predicting module 32 also transmits severe expulsion data to the expulsion data store 40. The predicting module 32 transmits the plurality of welding parameters to the welding parameters data store 38. The predicting module 32 is further configured to output a signal to the indicator 16 indicative of the nugget size. Additionally, the predicting module 32 is configured to retrieved and transmit any one of weld data, welding parameter data, and expulsion data to the indicator 16.

The expulsion defector 34 is configured to determine whether an expulsion has occurred for the weld nugget 24. An expulsion is indicative of a sudden drop in a dynamic resistance of the pair of electrodes 18. Expulsion reduces the nugget size and even more energy is needed to deliver and produce the weld nugget 24. In an expulsion event, a portion of the molten nugget is ejected away, leaving less material to form the weld nugget 24. An expulsion has detrimental effects on the quality of a weld 22, and therefore it should always be avoided. For nugget size predictions, every expulsion generates a sudden change in the tip voltage and the weld current signal. This affects the continuity of any nugget-size-prediction algorithms. Since weld strength will be greatly reduced, the nugget size predictions for welds with severe expulsions have little meaning.

Additionally, expulsions generally occur in early and late stages of the welding process. Early stage and late stage expulsions can have different effects on the quality of the weld. Early stage expulsions usually do not lose much material. Their effects can be alleviated with following-on heating. Late stage expulsions usually lose a large amount of material, and therefore have more severe effects on the weld quality. As for the dynamic resistance, early stage expulsions usually generate small resistance drops, while late stage expulsions generate larger resistance drops. The severity of these two types of expulsions can be defined using the following equation,

ExpulsionSeverity=Δdr/dr Equation 11

where Δdr is a resistance drop because of the expulsion and dr is the resistance before the expulsion. Using this definition, the expulsion detector 34 compares the severity of expulsions based on the resistance drop.

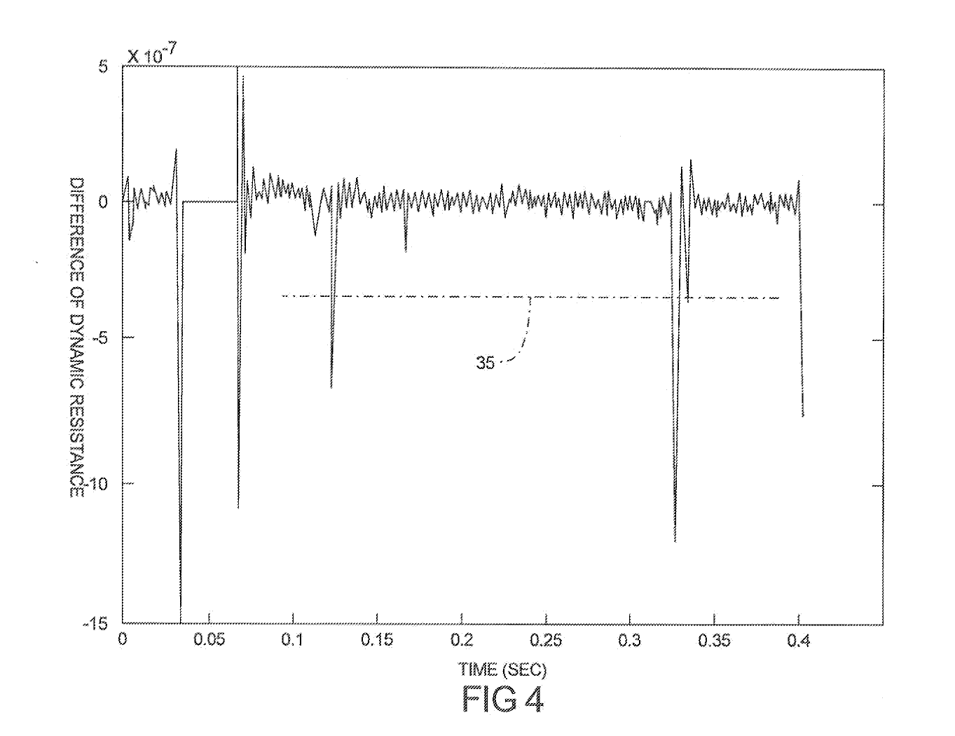

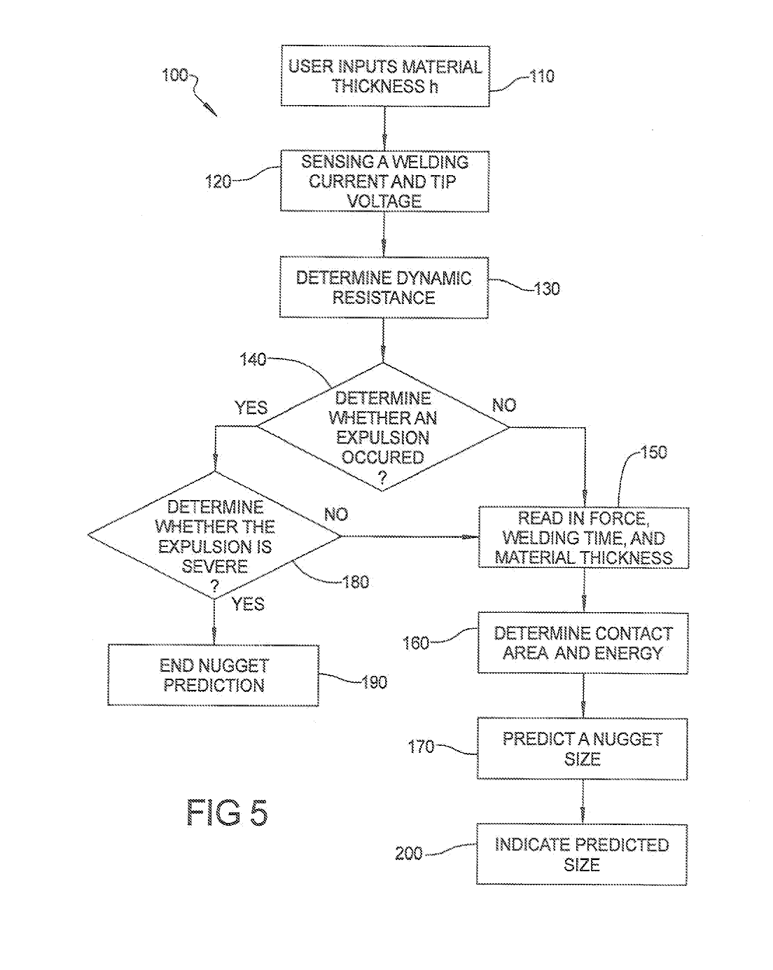

in determining an expulsion, the expulsion detector 34 is configured to receive a determined dynamic resistance from the predicting module 32 to detect whether the expulsion has occurred. An expulsion occurs when the determined dynamic resistance for the weld nugget 24 indicates a sharp dip using a dynamic resistance curve model. The expulsion detector 34 retrieves a plurality of dynamic resistances previously transmitted to the welding parameters data store by the predicting module 32. The dynamic resistance curve model is configured using the plurality of dynamic resistances determined over a period of time during the resistance spot welding process. FIG. 4 illustrates an exemplary dynamic resistance curve model. The sharp dip is indicative of a sudden loss of molten sheet metal that in turn indicates that an expulsion has occurred as stated above. Additionally, the expulsion detector 34 detects the sharp dip by setting a dynamic resistance threshold 35 based on the sampling rate, noise level, and acceptable type-I and type-II errors, as shown in FIG. 4. Thus, the tip voltage and the current signal that is used to determine the dynamic resistance are filtered to remove random large noise. If no expulsion is determined, the expulsion detector 34 sends a signal to the predicting module 32 in response thereto.

If the expulsion detector 34 detects an expulsion, the expulsion detector 34 is further configured to compare the expulsion to a predetermined severe expulsion threshold. A severe expulsion is indicative an expulsion that is above the expulsion threshold. The expulsion detector 34 transmits a signal to the predicting module 32 to ignore the nugget size of the weld nugget 24. In other words, the predicting module 32 disregards the nugget size when the severe expulsion is detected. Otherwise, the expulsion detector 34 transmits a signal to the predicting module 32 to proceed with determining the nugget size.

The weld data store 36 stores a plurality of weld data. The weld data includes an identifier, where a weld nugget 24 is used by the nugget prediction system 14 to request and retrieve specific data. The weld data comprises a time indicator indicative of a date and time that the weld nugget 24 occurred, where the weld data is used by the system to request and retrieve specific weld data. The weld data further includes a severe expulsion identifier indicating whether an expulsion occurred for the weld nugget 24. The weld data also includes at least one welding parameter identifier, where the at least one welding parameter is selected and retrieved based on the weld data requested.

The welding parameters data store 38 stores the plurality of welding parameters. Each welding parameter datum is indicative of a specific welding parameter under which the weld nugget 24 was formed. Each welding parameter data also includes a welding parameter identifier, where the welding parameter identifier is used by the nugget prediction system 14 to request and retrieve specific welding parameter data. The welding parameter further includes a welding time, where the welding time indicates a date and time of day that the weld nugget 24 was formed. Each welding parameter data also includes a weld identifier, which corresponds to specific weld data in the weld data store 36.

The severe expulsion data store 40 stores expulsion data. Each severe expulsion data is indicative of a severe expulsion that has occurred for a weld nugget 24. Each severe expulsion data also includes a severe expulsion identifier, where the severe expulsion identifier is identified by the nugget prediction system 14 to request and retrieve specific severe expulsion data. Each severe expulsion data also includes a time indicator to indicate a date and time of date when the severe expulsion occurred. The severe expulsion data may also include a weld identifier, where the weld identifier corresponds to a specific weld data stored within the weld data store 36.

The indicator 16 is configured to receive the signal indicating the predicted nugget size. The indicator 16 is further operable to alert the operator of the predicted nugget size. More specifically, the indicator 16 displays the predicted nugget size to the operator. The indicator 16 is also configured to receive and alert the operator of any one of the weld data, welding parameter data, and expulsion data. The indicator 16 may comprise a display unit. The display unit 16 displays to the operator any one of weld data, welding parameter data, and expulsion data received by the indicator 16 along with any appropriate associated units of measurement. Additionally, the display unit 16 may also display any one of the weld data, the welding parameter data, and the expulsion data in a graphical or chart form.

Additionally, each of the predicting module 32, the expulsion detector 34, the weld data store 36, the welding parameters data store 38, and the expulsion data store 40 may be comprised within a processor-based control unit, such that the processor-based control unit performs the functions and features of each element as stated above.

With reference to FIG. 5, in an operation 100, a plurality of metal materials 20 are placed between the pair of electrodes 18 for welding using the welding system 12. The welding system 12 produces a plurality of welding parameters to marry a welded plurality of metal materials. At operation 110, the operator inputs the material thickness for each one of the plurality of metal materials 20 using the user interface 30. As the plurality of metal materials 20 are welded forming the welded plurality of metal materials, the current and voltage sensors 26, 28 sense the weld current signal and the tip voltage at operation 120.

Based on the tip voltage and the weld current signal, the predicting module 32 determines the dynamic resistance at operation 130 in accordance with Equation 6. The predicting module 32 transmits the dynamic resistance to the expulsion detector 34.

Additionally, the expulsion defector 34 determines whether an expulsion has occurred at operation 140. If no expulsion has occurred, the predicting module 32 retrieves and reads the weld force, the weld time, and each material thickness for each of the plurality of metal materials 20 at operation 150. The predicting module 32 also determines the contact area, in accordance with Equation 4, and the energy used to produce the weld nugget 24 at operation 160. Using the welding parameters, the predicting module 32 predicts the nugget size of the weld nugget 24 in accordance with Equation 10 at operation 170.

If an expulsion has occurred, the predicting module 32 signals the expulsion detector 34 to determine whether the expulsion is severe at operation 180. The expulsion detector 34 compares the expulsion to the severe expulsion threshold in accordance with equation 11. if the expulsion is severe, the expulsion detector 34 sends the predicting module 32 a signal in response thereof, in response to the signal, the predicting module 32 ends the nugget prediction algorithm at operation 190. If the expulsion is not severe, the expulsion defector 34 transmits the signal to notify the predicting module 32 to proceed in determining the nugget size of the weld nugget 24. In operation 170, the predicting module 32 predicts the nugget size.

After determining the nugget size, the prediction module 32 determines whether the nugget size is an acceptable nugget size. The prediction module 32 compares the nugget size to a predetermined minimum nugget size threshold and sends an acceptance signal to the indicator 16 in response thereof. The predicting module 32 also transmits the nugget size to the indicator 16. Upon receipt of both signals, the indicator 16 alerts the operator of the nugget size for the weld nugget 24 at operation 200. Additionally, the indicator 16 informs the operator of whether the nugget size is acceptable based on the acceptance signal. More specifically, the indicator 16 may display the nugget size to the operator and indicate whether the nugget size was acceptable,

Upon request by the operator, the user interface 30 may send a request signal for retrieval of at least one specific welding parameter data for a specific period. The request is received and processed by the predicting module 32. The predicting module 32 retrieves the specific welding parameter data from the welding parameters data store 38. The at least one specific welding parameter data is then transmitted to the indicator 16. The indicator 16 alerts the operator of the at least one specific welding parameter data. More specifically, the indicator 16 displays the at least one specific welding parameter data in a graphical or chart form for the selected period to the operator.

For example, the operator may initiate a request for a plurality of nugget sizes for a plurality of weld nuggets associated with a requested period. The user interface 30 sends the request signal to the predicting module 32. Upon receipt of the request signal, the predicting module 32 retrieves a requested nugget size data for the requested period from the welding parameters data store 38. Afterwards, the predicting module 32 sends the nugget size data to the indicator 16. The indicator 16 displays the requested weld data and the nugget size data for the requested period in a graph or chart form.

Utilizing the user interface 30, the operator may also request severe expulsion data. The user interface 30 sends a request signal for severe expulsion data for a specific period to the predicting module 32. The predicting module 32 retrieves a requested severe expulsion data for the specific period from the severe expulsion data store 40. The predicting module 32 transmits the requested severe expulsion data to the indicator 16. The indicator 16 alerts the operator of the requested severe expulsion data for the specific period. The indicator 16 may display the requested severe expulsion data in a graphical or chart form to the operator.

Additionally, the operator may initiate a request for weld data for a period. The user interface 30 sends the request signal for weld data regarding the period to the predicting module 32. The predicting module 32 receives the request signal and retrieves the weld data from the weld data store 36. Additionally, the predicting module 32 sends the weld data to the indicator 16. The indicator 16 alerts the operator of the weld data for the period. More specifically, the indicator 16 displays the weld data in a graphical or chart form.

For example, the indicator 16 may display the weld data such that specific weld data indicates a nugget size of a weld nugget 24 such that the weld nugget 24 is color-coded. In other words, the indicator 16 may display the weld nugget 24 in a blue, if the nugget size for the weld nugget 24 is above the minimum nugget size threshold based on the acceptance signal. An acceptable weld nugget size of the weld nugget 24 indicates that a predicted nugget size is above the minimum nugget size threshold. If the predicted nugget size is below the minimum nugget size threshold, the indicator 16 may display the weld nugget 24 in yellow to indicate a warning to the operator. In addition, the indicator 16 may display the weld nugget 24 in a red color, if the predicted nugget size 24 is below the minimum nugget size threshold.

What is claimed is:

1. A resistance spot welding monitoring system, comprising:
a plurality of sensors adapted to be coupled to a resistance spot welding system for receipt of welding data, wherein the welding data is indicative of the welding parameters used to produce a weld nugget;
a nugget prediction system coupled to the plurality of sensors and configured to retrieve the welding data, wherein the nugget prediction system is operable to predict a nugget size based upon the welding data received from the plurality of sensors, and to generate a nugget size signal; and
an indicator coupled to the nugget prediction system and operably receiving the nugget size signal, wherein the indicator notifies an operator of a predicted nugget size.

2. The resistance spot welding monitoring system of claim 1, wherein the welding data include electrical energy data and contact area data used to form the weld nugget.

3. The resistance spot welding monitoring system of claim 2, wherein the contact area is a function of a dynamic resistance associated with a welded plurality of materials.

4. The resistance spot welding monitoring system of claim 2, wherein the electrical energy data further comprises:
a welding current and a tip voltage associated with a pair of electrodes of the resistance spot welding system.

5. The resistance spot welding monitoring system of claim 2, wherein the welding data further comprises at least one of the following:
material thickness data;
welding time;
electrode force; and
dynamic resistance.

6. The resistance spot welding monitoring system of claim 1, wherein the nugget prediction system is further operative to determine whether a severe expulsion occurs during a welding operation.

7. The resistance spot welding monitoring system of claim 6, wherein the nugget prediction system ignores the nugget size whenever a severe expulsion is determined.

8. The resistance spot welding monitoring system of claim 6, wherein the nugget prediction system compares a detected expulsion to a predetermined expulsion threshold to determine whether a severe expulsion has occurred.

9. The resistance spot welding monitoring system of claim 8, wherein the detected expulsion is indicative of a sudden drop in dynamic resistance when a dynamic resistance for the weld nugget is compared with at least one previously obtained dynamic resistance.

10. The resistance spot welding monitoring system of claim 1, wherein the nugget prediction system further comprises a user interface configured to allow an operator to input at least one of the welding parameters.

11. The resistance spot welding monitoring system of claim 1, wherein the nugget size is predicted based on
$${d}_{n}^{2} = {α}_{0} + {α}_{1} ( \frac{E}{h} ) + {α}_{2} ( \frac{{d}_{c}^{2} \cdot Δ t}{h} ) + {α}_{3} ( {d}_{c} \cdot Δ t ) + {α}_{4} F ,$$
wherein h is the thickness of the material, dₙ is the nugget size, ΔTₘ is the temperature increase from the room temperature to the melting temperature of the plurality of materials 20, Δt is the welding time, F is the electrode force, αs are calibrated coefficients of the linear equation, and d_{c} is the contact area.

12. A method for monitoring resistance spot welding, comprising:
sensing welding data associated with a welding operation forming a weld nugget within a plurality of materials, wherein the weld data is indicative of welding parameters used to produce the weld nugget;
predicting a nugget size of the weld nugget based upon the welding parameters; and
notifying an operator of a predicted nugget size.

13. The method of claim 12, further comprising:
determining whether a severe expulsion occurred during the welding operation; and,
ignoring the predicted nugget size whenever the severe expulsion is determined.

14. The method of claim 13, wherein determining whether the severe expulsion occurs further comprises:
comparing a detected expulsion associated with the weld nugget to a predetermined severe expulsion threshold.

15. The method of claim 14, wherein the severe expulsion occurs when a detected expulsion for the weld nugget is above the predetermined severe expulsion threshold.

16. The method of claim 15, wherein the detected expulsion is indicative of a sudden drop in dynamic resistance when a dynamic resistance for the weld nugget is compared with at least one previously obtained dynamic resistance.

17. The method of claim 12, wherein the welding parameters further comprise at least one of the following:
electrical energy;
contact area;
material thickness data associated with each of the plurality of sheet metals;
welding time;
dynamic resistance; and
electrode force.

18. The method of claim 17, wherein the contact area is a function of the dynamic resistance associated with forming the weld nugget.

19. The method of claim 18, wherein the dynamic resistance is determined by
$${R}_{T} = {\int }_{0}^{h} {ρ}_{r} \frac{1}{{A}_{x}} d x = {\int }_{0}^{h} {ρ}_{r} \frac{1}{{π ( r + {r}_{e} ( 1 - \frac{x}{h} ) )}^{2}} d x = {ρ}_{T} \frac{h}{π r ( r + {r}_{e} )} ,$$
wherein r is a contact radius at the electrode to surface interface, rₑ is the difference between the contact radius at the surface-to-surface interface and the electrode-to-interface surface, h is a thickness of each of the plurality of metal materials, Tₒ is an ambient temperature of a welding zone, k₁ and k₂ are heat transfer coefficients related to thermal conductivities of the pair of electrodes 18 and the plurality of materials, Aₜ is the contact area at the pair of electrodes 18 to surface interfaces, and Aₛ is the side surface area of the lumped volume, where ρ_{T} is a temperature dependent electrical resistance.

20. The method of claim 12, wherein the nugget size is determined by
$${d}_{n}^{2} = {α}_{0} + {α}_{1} ( \frac{E}{h} ) + {α}_{2} ( \frac{{d}_{c}^{2} \cdot Δ t}{h} ) + {α}_{3} ( {d}_{c} \cdot Δ t ) + {α}_{4} F ,$$
wherein h is the thickness of the material, dₙ is the nugget size, ΔTₘ is the temperature increase from the room temperature to the melting temperature of the plurality of metal materials, Δt is the welding time, F is the electrode force, as are calibrated coefficients of the linear equation, and d_{c} is the contact area.
